(19) United States
(12) Patent Application Publication
(10) Pub. No.: US 2026/0246649 A1
(43) Pub. Date: Aug. 20, 2026

(54) DATA SECURITY FOR REPLAY PROTECTED MEMORY BLOCK (RPMB)

(71) Applicant: QUALCOMM Incorporated, San Diego, CA (US)

(72) Inventors: Sridhar Anumala, Hyderabad (IN); Hung Vuong, San Clemente, CA (US); Abhishek Mishra, Ranchi (IN); Can Guo, Shanghai (CN); Yashavantha Rao, Bangalore (IN); Sanjay Verdu, Tirupati (IN)

(21) Appl. No.: 19/145,165

(22) PCT Filed: Feb. 15, 2023
(86) PCT No.: PCT/CN2023/076088

§ 371 Date: Jul. 1, 2025

(51) Int. Cl. H04L 9/32

(52) U.S. Cl. CPC H04L 9/3242

(57) ABSTRACT

This disclosure provides systems, methods, and devices for memory systems that support authenticating access to a secured portion of a memory device, such as a replay protected memory block (RPMB) in a flash storage system. In a first aspect, a method of processing data for a memory system includes performing authentication on the flash storage system comparing a message authentication codes (MACs) included as part of a read request received by the flash memory with a MAC determined by the flash memory before releasing data from the RPMB region to a host device. Other aspects and features are also claimed and described.

### TECHNICAL FIELD

Aspects of the present disclosure relate generally to an apparatus and method for controlling a memory device. Some aspects may, more particularly, relate to an apparatus and method for controlling operations for protection of data communicated to a memory storage device.

### INTRODUCTION

As the value and use of information continues to increase, individuals and businesses seek additional ways to process and store information. In addition, the use of information in various locations and desired portability of information is increasing. For this reason, users are increasingly turning towards the use of portable electronic devices, such as mobile phones, digital cameras, laptop computers and the like. Portable electronic devices generally employ a memory system using a memory device for storing data. A memory system may be used as a main memory or an auxiliary memory of a portable electronic device.

The memory device of the memory system may include one kind or a combination of kinds of storage. For example, magnetic-based memory systems, such as hard disk drives (HDDs), store data by encoding data as a combination of small magnets. As another example, optical-based memory systems, such as digital versatile discs (DVDs) and Blu-ray media, store data by encoding data as physical bits that cause different reflections when illuminated by a light source. As a further example, electronic memory devices store data as collections of electrons that can be detected through voltage and/or current measurements.

Electronic memory devices can be advantageous in certain systems in that they may access data quickly and consume a small amount of power. Examples of an electronic memory device having these advantages include universal serial bus (USB) memory devices (sometimes referred to as “memory sticks”), a memory card (such as used in some cameras and gaming systems), and solid state drive (SSDs) (such as used in laptop computers). NAND flash memory is one kind of memory device that may be used in electronic memory devices. NAND flash memory is manufactured into memory cards or flash disks. Example memory cards include compact flash (CF) cards, multimedia cards (eMMCs), smart media (SM) cards, and secure digital (SD) cards.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Data stored in electronic memory may be used for securing an electronic device, securing content on the electronic device, or maintain user secrecy. For example, a memory may store information such as encryption keys, digital rights management (DRM) certificates authorizing access to certain copyrighted works, or the like. Protection of the data, such as these keys or certificates, is important to protect the user and/or the information. A replay protected memory block (RPMB) portion of a memory module may be used to store such information in a secure manner. However, memory devices with RPMB capability do not provide sufficient security when authenticating access to the secured data of the RPMB portion.

Aspects of this disclosure provide techniques for authenticating read requests to protected portions of memory, such as a replay protected memory block (RPMB) portion of a memory module. For example, data may not be permitted to leave the memory module until a read request is authenticated to demonstrate that a requesting application or virtual machine executing on a host device has permission to access the RPMB portion identified by the read request.

In one aspect of the disclosure, a memory device includes a memory controller coupled to a memory module through a first channel and configured to access data stored in the memory module through the first channel; and coupled to a host device through a first interface and configured to communicate with the host device over the first interface. The memory controller of the memory device may be configured to perform operations including receiving a read request for requested data stored in a replay protected memory block (RPMB) portion of the memory module, wherein the read request comprises first information corresponding to the RPMB portion and a first message authentication code (MAC) determined by the host device based on at least a portion of the first information; determining a second message authentication code (MAC) based on second information stored in the memory module and the first information; determining whether the read request is valid based on comparing the first MAC with the second MAC; and transmitting the requested data to the host device through the first interface based on the determining whether the read request is valid. In another aspect of the disclosure, a method for performing these operations by a processor by executing instructions stored in a memory coupled to the processor is also disclosed. In an additional aspect of the disclosure, a non-transitory computer-readable medium stores instructions that, when executed by a processor, cause the processor to perform these operations.

In an additional aspect of the disclosure, an apparatus includes a memory controller of a host device configured to couple the host device to a memory system through a first interface, the memory controller configured to perform operations including transmitting a read request for requested data stored in a replay protected memory block (RPMB) portion of the memory system, the read request comprising a first message authentication code (MAC) based on first information corresponding to the RPMB portion, the first information comprising at least an address, a nonce, a block count, and a write counter; and receiving a read response from the memory system, wherein the read response is based on the memory system determining whether the read request is valid based on comparing the first message authentication code (MAC) and a second message authentication code (MAC) determined by the memory system. In another aspect of the disclosure, a method for performing these operations by a processor by executing instructions stored in a memory coupled to the processor is also disclosed. In an additional aspect of the disclosure, a non-transitory computer-readable medium stores instructions that, when executed by a processor, cause the processor to perform these operations.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a data processing system including a memory system in accordance with an embodiment of the present invention.

FIG. 2 is a block diagram illustrating an example electronic device including the memory system according to one or more aspects of the disclosure.

FIGS. 3A-C are a block diagram illustrating an electronic device with an encrypted channel to a storage device's replay protected memory bank (RPMB) according to one or more aspects of the disclosure.

FIG. 4 is a block diagram illustrating authentication of a read request according to one or more aspects of the disclosure.

FIG. 5A is a flow chart illustrating an authenticated read request according to one or more aspects of the disclosure.

FIG. 5B is a flow chart illustrating an authenticated read request according to one or more aspects of the disclosure.

FIG. 6 is a block diagram illustrating details of an example wireless communication system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support data processing, including techniques for storing, retrieving, and organizing data in a memory system. In particular, aspects of this disclosure provide for authentication of read requests to protected portions of memory, such as a replay protected memory block (RPMB) portion of a memory module. For example, data may not be permitted to leave the memory module until a read request is authenticated to demonstrate that a requesting application or virtual machine executing on a host device has permission to access the RPMB portion identified by the read request.

Particular implementations of the subject matter described in this disclosure may be implemented to realize one or more of the following potential advantages or benefits. In some aspects, the present disclosure provides techniques for improved confidentiality of user data by reducing the likelihood of, or preventing, a threat actor obtaining unauthorized access to secure data stored in a replay protected memory block (RPMB) portion of a memory module.

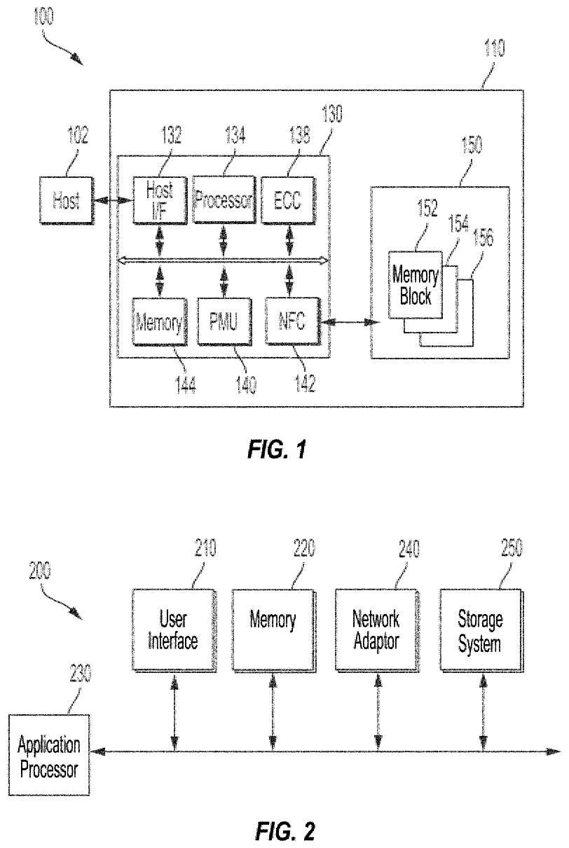

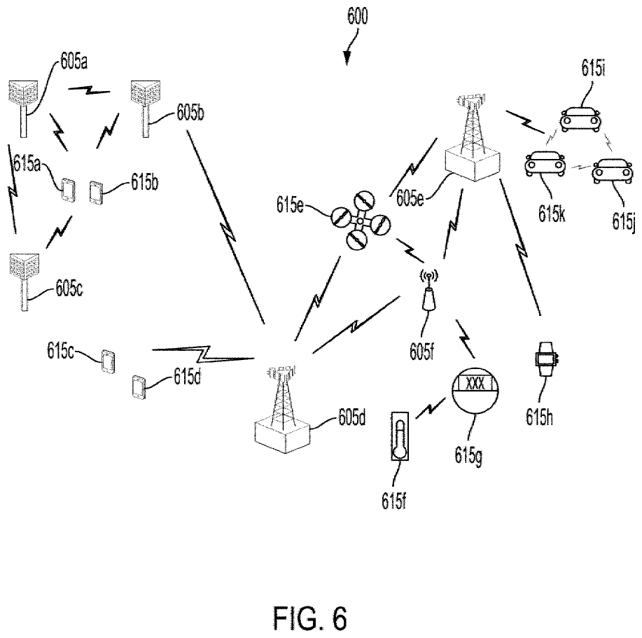

Memory may be used in a computing system organized as illustrated in FIG. 1. FIG. 1 illustrates a data processing system 100, such as may be included in a mobile computing device, according to one or more aspects of the disclosure. A memory system 110 may couple to a host device 102 through one or more channels. For example, the host device 102 and memory system 110 may be coupled through a serial interface including a single channel for the transport of data or a parallel interface including two or more channels for the transport of data. In some aspects, control data may be transferred through the same channel(s) as the data or the control data may be transferred through additional channels. The host device 102 may be, for example, a portable electronic device such as a mobile phone, an MP3 player, a laptop computer, or a non-portable electronic device such as a desktop computer, a game player, a television (TV), a media player, or a projector. Additional example host devices are illustrated and described with reference to FIG. 6.

The memory system 110 may execute operations in response to commands (e.g., a request) from the host device 102. For example, the memory system 110 may store data provided by the host device 102 and the memory system 110 may also provide stored data to the host device 102. The memory system 110 may be used as a main memory, short-term memory, or long-term memory by the host device 102. As one example of main memory, the host device 102 may use the memory system 110 to supplement or replace a system memory by using the memory system 110 to store temporary data such as data relating to operating systems and/or threads executing in the operation system. As one example of short-term memory, the host device 102 may use the memory system 110 to store a page file for an operating system. As one example of long-term memory, the host device 102 may use the memory system 110 to store user files (e.g., documents, videos, pictures) and/or application files (e.g., word processing executable, gaming application).

The memory system 110 may be implemented with any one of various storage devices, according to the protocol of a host interface for the one or more channels coupling the memory system 110 to the host device 102. The memory system 110 may be implemented with any one of various storage devices, such as a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, or a memory stick.

The memory system 110 may include a memory module 150 and a controller 130 coupled to the memory module 150 through one or more channels. The memory module 150 may store and retrieve data in memory blocks 152, 154, and 156 under control of the controller 130, which may execute commands received from the host device 102. The controller 130 is configured to control data exchange between the memory module 150 and the host device 102. The storage components, such as blocks 152, 154, and 156 in the memory module 150 may be implemented as volatile memory device, such as, a dynamic random access memory (DRAM) and a static random access memory (SRAM), or a non-volatile memory device, such as a read only memory (ROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (SCRAM), or a NAND flash memory.

The controller 130 and the memory module 150 may be formed as integrated circuits on one or more semiconductor dies (or other substrate). In some aspects, the controller 130 and the memory module 150 may be integrated into one chip. In some aspects, the memory module 150 may include one or more chips coupled in series or parallel with each other and coupled to the controller 130, which is on a separate chip. In some aspects, the memory module 150 and controller 130 chips are integrated in a single package, such as in a package on package (PoP) system. In some aspects, the memory system 110 is integrated on a single chip with one or more or all of the components (e.g., application processor, system memory, digital signal processor, modem, graphics processor unit, memory interface, input/output interface, network adaptor) of the host device 102, such as in a system on chip (SoC). The controller 130 and the memory module 150 may be integrated into one semiconductor device to form a memory card, such as, for example, a Personal Computer Memory Card International Association (PCMCIA) card, a compact flash (CF) card, a smart media card (SMC), a memory stick, a multimedia card (MMC), an RS-MMC, a micro-MMC, a secure digital (SD) card, a mini-SD, a micro-SD, an SDHC, and a universal flash storage (UFS) device.

The controller 130 of the memory system 110 may control the memory module 150 in response to commands from the host device 102. The controller 130 may execute read commands to provide the data from the memory module 150 to the host device 102. The controller 130 may execute write commands to store data provided from the host device 102 into the memory module 150. The controller 130 may execute other commands to manage data in the memory module 150, such as program and erase commands. The controller 130 may also execute other commands to manage control of the memory system 110, such as setting configuration registers of the memory system 110. By executing commands in accordance with the configuration specified in the configuration registers, the controller 130 may control operations of the memory module 150, such as read, write, program, and erase operations.

The controller 130 may include several components configured for performing the received commands. For example, the controller 130 may include a host interface (I/F) unit 132, a processor 134, an error correction code (ECC) unit 138, a power management unit (PMU) 140, a NAND flash controller (NFC) 142, and/or a memory 144. The power management unit (PMU) 140 may provide and manage power for components within the controller 130 and/or the memory module 150.

The host interface unit 132 may process commands and data provided from the host device 102, and may communicate with the host device 102, through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (PATA), small computer system interface (SCSI), enhanced small disk interface (ESDI), and integrated drive electronics (IDE). For example, the host interface 132 may be a parallel interface such as an MMC interface, or a serial interface such as an ultra-high speed class 1 (UHS-I)/UHS class 2 (UHS-II) or a universal flash storage (UFS) interface.

The ECC unit 138 may detect and correct errors in the data read from the memory module 150 during the read operation. The ECC unit 138 may not correct error bits when the number of the error bits is greater than a threshold number of correctable error bits, which may result in the ECC unit 138 outputting an error correction fail signal indicating failure in correcting the error bits. In some aspects, no ECC unit 138 may be provided or the ECC unit 138 may be configurable to be active for some or all of the memory module 150. The ECC unit 138 may perform an error correction operation using a coded modulation such as a low-density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), or a Block coded modulation (BCM).

The NFC 142 provides an interface between the controller 130 and the memory module 150 to allow the controller 130 to control the memory module 150 in response to a commands received from the host device 102. The NFC 142 may generate control signals for the memory module 150, such as signals for rowlines and bitlines, and process data under the control of the processor 134. Although NFC 142 is described as a NAND flash controller, other controllers may perform similar function for other memory types used as memory module 150.

The memory 144 may serve as a working memory of the memory system 110 and the controller 130. The memory 144 may store data for driving the memory system 110 and the controller 130. When the controller 130 controls an operation of the memory module 150 such as, for example, a read, write, program or erase operation, the memory 144 may store data which are used by the controller 130 and the memory module 150 for the operation. The memory 144 may be implemented with a volatile memory such as, for example, a static random access memory (SRAM) or a dynamic random access memory (DRAM). In some aspects, the memory 144 may store address mappings, a program memory, a data memory, a write buffer, a read buffer, a map buffer, and the like.

The processor 134 may control the general operations of the memory system 110, and a write operation or a read operation for the memory module 150, in response to a write request or a read request received from the host device 102, respectively. For example, the processor 134 may execute firmware, which may be referred to as a flash translation layer (FTL), to control the general operations of the memory system 110. The processor 134 may be implemented, for example, with a microprocessor or a central processing unit (CPU), or an application-specific integrated circuit (ASIC).

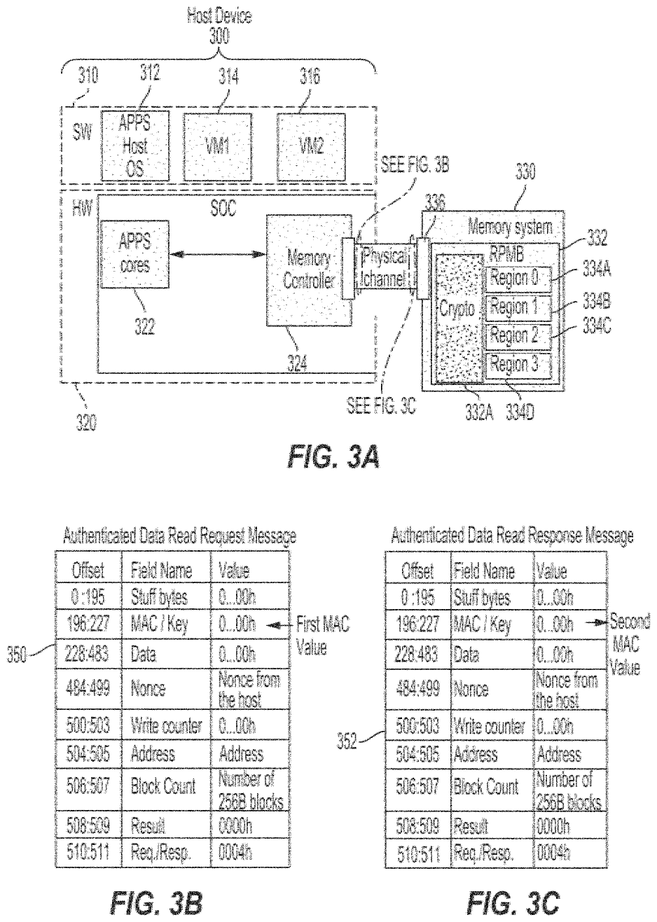

FIG. 2 is a block diagram illustrating an example electronic device including the memory system 100 according to one or more aspects of the disclosure. The electronic device 200 may include a user interface 210, a memory 220, an application processor 230, a network adaptor 240, and a storage system 250 (which may be one embodiment of the memory system 100 of FIG. 1). The application processor 230 may be coupled to the other components through a bus, such as a peripheral component interface (PCI) bus, including a PCI express (PCIe) bus.

The application processor 230 may execute computer program code, including applications, drivers, and operating systems, to coordinate performing of tasks by components included in the electronic device 200. For example, the application processor 230 may execute a storage driver for accessing the storage system 250. The application processor 230 may be part of a system-on-chip (SoC) that includes one or more other components shown in electronic device 200.

The memory 220 may operate as a main memory, a working memory, a buffer memory or a cache memory of the electronic device 200. The memory 220 may include a volatile random access memory such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDRAM, an LPDDR2 SDRAM, an LPDDR3 SDRAM, an LPDDR4 SDRAM, an LPDDR5 SDRAM, or an LPDDR6 SDRAM, or a nonvolatile random access memory such as a phase change random access memory (PRAM), a resistive random access memory (ReRAM), a magnetic random access memory (MRAM) and a ferroelectric random access memory (FRAM). In some aspects, the application processor 230 and the memory 220 may be combined using a package-on-package (POP).

The network adaptor 240 may communicate with external devices. For example, the network adaptor 240 may support wired communications and/or various wireless communications such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (Wi-Di), and so on, and may thereby communicate with wired and/or wireless electronic appliances, for example, a mobile electronic appliance.

The storage system 250 may store data, for example, data received from the application processor 230, and transmit data stored therein, to the application processor 230. The storage system 250 may be a non-volatile semiconductor memory device, such as a phase-change RAM (PRAM), a magnetic RAM (MRAM), a resistive RAM (ReRAM), a NAND flash memory, a NOR flash memory, or a 3-dimensional (3-D) NAND flash memory. The storage system 250 may be a removable storage medium, such as a memory card or an external drive. For example, the storage system 250 may correspond to the memory system 110 described above with reference to FIG. 1 and may be a SSD, eMMC, UFS, or other flash memory system.

The user interface 210 provide one or more graphical user interfaces (GUIs) for inputting data or commands to the application processor 230 or for outputting data to an external device. For example, the user interface 210 may include user input interfaces, such as a virtual keyboard, a touch screen, a camera, a microphone, a gyroscope sensor, or a vibration sensor, and user output interfaces, such as a liquid crystal display (LCD), an organic light emitting diode (OLED) display device, an active matrix OLED (AMOLED) display device, a light emitting diode (LED), a speaker, or a haptic motor.

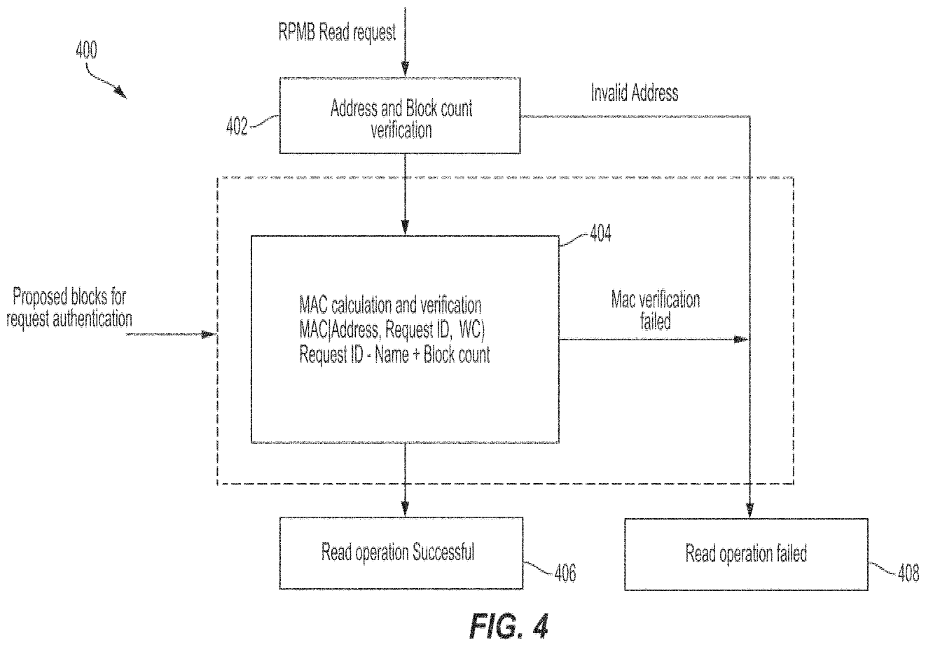

One electronic device with encryption protecting a memory interface is shown in FIG. 3A and example messages communicated on the interface shown in FIGS. 3B-3C. FIG. 3A is a block diagram illustrating an electronic device with an encrypted channel to a storage device according to one or more aspects of the disclosure. A host device 300 may include software 310 executing on hardware 320. The software 310 may include applications 312 executing in a host operating system and/or one or more virtual machines 314, 316. The software 310 may execute on application processor cores 322. The application cores 322 may be coupled to a memory controller 324 that provides an interface between the application processor cores 322 and a memory system 330 over one or more physical channels. The memory controller 324 may also provide an interface to the memory system 330 for the virtual machines 314 and 316.

In some embodiments, the interface between the memory controller and the memory device may be a universal flash storage (UFS) interface, with the memory controller 324 being a UFS memory controller and the memory system 330 being a UFS memory device 330. In some embodiments, the host device 300 and the memory system 330 may be integrated in a single package as two different integrated circuits using a multi-chip packaging technique. In some embodiments, the host device 300 and the memory system 330 may be a single integrated circuit with the host device 300 and the memory system 330 contained on a single semiconductor die. Although UFS example embodiments may be described herein, aspects of this disclosure may be applied to other memory systems, including any of the memory systems described with reference to FIG. 1.

The memory system 330 may include a controller 336 for interfacing over the physical channel with the memory controller 324. The memory system 330 may also include a Replay Protected Memory Block (RPMB) portion 332 of a memory module configured to store secure application data that provides replay protection. For example, RPMB portion 332 may protect data written in certain regions from being overwritten (such as through a Write Protect Until Power Cycle or Permanent Write Protect status). RPMB portion 332 may be used by software to reduce or prevent a downgrade attack that overwrites a software version authentication or may be used by software for secure boot that prevents undesired code from running on a device.

The RPMB portion 332 may include one or more defined regions 334A-D. The regions 334A-D may be a portion of one of the memory blocks 152, 154, 156 of FIG. 1 or may be one of the memory blocks 152, 154, 156 dedicated to RPMB. The regions 334A-D may be assigned to different clients to store data specific to that client and protected from read or write by other clients. For example, a first application may store first data in region 334A, a second application may store second data in region 334B, and the virtual machine 314 may store third data in region 334C. The first application may be prevented by the memory system 330 from accessing data stored in the regions 334B and 334C. The regions 334A-D may be used by the software 310 and/or the virtual machines 314 and 316 to store information relating to digital rights management (DRM) (e.g., keys for accessing protected media content in a media player application), biometric data (e.g., fingerprints, face authentication data, iris authentication data), a secure file system key, a user identifier, a password, and/or software roll-back versions (e.g., anti-rollback versions of trusted applications).

Each of the RPMB regions 334A-D may have corresponding information stored in the memory system 330. For example, the memory system 330 may separately track a write counter for each RPMB region 334A-D indicating a total amount of successful authenticated data write operations. The write counter may allow an application that owns one of the RPMB regions to identify if a malicious process or inadvertent operation has overwritten data in the RPMB regions. As another example of information corresponding to the RPMB regions, the memory system 330 may separately store an authentication key for each RPMB region 334A-D. The authentication key may be provisioned by a client (e.g., an application or a virtual machine) by providing a seed key to the memory system 330 from which an authentication key is derived by a confidential hash algorithm.

A cryptography engine 332A may be included in the RPMB portion 332 or elsewhere in the memory system 330 to facilitate authentication operations regarding read or write operations to the RPMB regions 334A-D. For example, the cryptography engine 332A may include a key memory space for storing the authorization keys. They key memory space may be sized or allocated from a shared memory. As another example, the cryptography engine 332A may also include logic circuitry for determining a hash value based on certain inputs. The logic circuitry for determining the hash value may be configured to calculate hash values based on inputs from a host device 300 (such as first information received in a RPMB read request message from the host device 300) or a memory in the memory system 330 (such as second information stored or determined by the memory system 330 about the RPMB regions 334A-D). Logic within the cryptography engine 332A or the memory controller 336 may be configured to determine whether access to one of the regions 334A-D is authorized.

In one embodiment for accessing the RPMB regions 334A-D, the memory controller 324 may transmit an authenticated data read request message 350. The read request message 350 may share a common message structure as a response message 352 also transmitted over the physical channel. Different portions of the message may be empty, zero, or some other null value when a field is not applicable to a request or response.

The request message 350 may include a plurality of values in a specified sequence of fields with specified field sizes such that each field is located at a certain byte offset from a first byte of the message 350. Each of the fields may correspond to a value. The request message 350 may include stuff bytes. The request message 350 may include a message authentication code (MAC) value, which is null in the request message 350. The request message 350 may also include data, which may be null in the request message 350. The request message 350 may also include a nonce value, which may be a random number generated by the host for requests. The nonce may be returned in the response message 352 and checked by the memory controller 324 to determine that a response message is authentic for a corresponding request message. The request message 350 may include a write counter value indicating the client's tracked number of writes to the RPMB region specified by an address field of the request message 350. The request message 350 may also include a block count indicating a number of logical blocks requested to be read beginning at the logical block address specified by the address field. The request message 350 may include a result field, which may be a null value in the request message 350.

The request message 350 may also include a request/response type code, which may be 0x0004 for an authenticated data read request. Other possible request type codes are shown in the table below:

| Code | Request Message Type |
|---|---|
| 0001h | Authentication key programming request |
| 0002h | Write Counter read request |
| 0003h | Authenticated data write request |
| 0004h | Authenticated data read request |
| 0005h | Result read request (Normal RPMB Mode only) |
| 0006h | Secure Write Protect Configuration Block write request |
| 0007h | Secure Write Protect Configuration Block read request |
| 0008h | RPMB Purge Enable Request |
| 0009h | RPMB Purge Status Read Request |
| Others | Reserved |

A response message 352 may be transmitted by the memory system 330 to the host device 300 in response to the receipt of request message 350. The response message 352 may include similar data fields as the request message 350, and in some embodiments may be formatted in a data frame in the same size and organization as the request message 350.

In the response message 352, the returned MAC may be a null value or the MAC corresponding to the data retrieved from one of the RPMB regions 334A-D and stored in the data field. One or more of the other fields of the response message 352 may be null values if unnecessary as part of the response, such as the write counter field, the address field, and/or the block count field. Some fields may be null depending on whether the read request was completed by the memory system 330. For example, when an authentication fails, the data field of the response message 352 may be null but include an error code in the response field.

The response message 352 may include a request/response type code, which may be 0x0400 for an authenticated data read response. Other possible response type codes are shown in the table below:

| Code | Response Message Type |
|---|---|
| 0100h | Authentication key programming response |
| 0200h | Write Counter read response |
| 0300h | Authenticated data write response |
| 0400h | Authenticated data read response |
| 0500h | Reserved |
| 0600h | Secure Write Protect Configuration Block write response |
| 0700h | Secure Write Protect Configuration Block read response |
| 0800h | RPMB Purge Enable Response |
| 0900h | RPMB Purge Status Read Response |
| Others | Reserved |

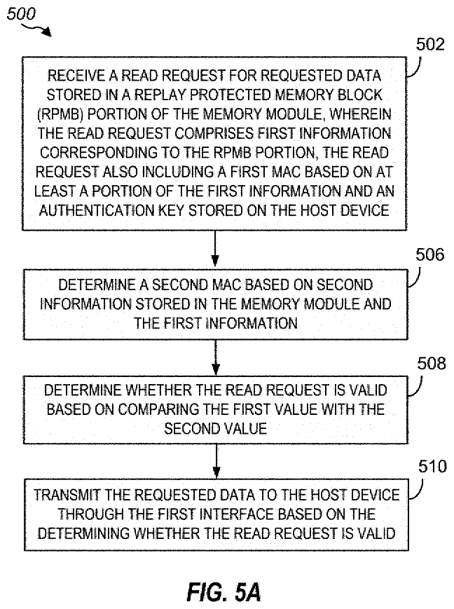

An example authentication operation performed by the memory system during access to the RPMB regions 334A-D by a host device is shown in FIG. 4. FIG. 4 is a block diagram illustrating authentication of a read request according to one or more aspects of the disclosure. An operation 400 includes receiving a RPMB Read Request Message and determining at block 402 whether the read request is for a valid address. Block 402 may include determining whether there are a block count number of blocks beginning at the specified address in one of the RPMB regions 334A-D. If not, the operation 400 returns a read operation failure at block 408. If the address and block count are verified then the operation 400 continues to block 404 to determine if the read request is valid as being authenticated.

At block 404, two values may be compared and verified as matching by the memory system 330. The values may be message authentication codes (MACs) computed from information in the RPMB Read Request Message. A first MAC may be determined by the host device and included in the RPMB Read Request Message. The first MAC is based on an address, a nonce, a block count, and a write counter of the RPMB Read Request Message and a first authentication key stored by the host device. A second MAC may be determined by the memory system based on the same information from the RPMB Read Request Message (e.g., an address, a nonce, and a block count of the RPMB Read Request Message, and a write counter stored in the memory system corresponding to the one of the RPMB Regions 334A-D specified by the address field), and the authentication key stored in the memory system for the one of the RPMB Regions 334A-D specified by the address field. If the MAC verification fails at block 404 then the operation 400 returns a read operation failure at block 408. If the MAC verification passes at block 404, such as by the first MAC and the second MAC being equal, then a RPMB Authenticated Read Response message may be transmitted by the memory system 330 to the host device 300. The RPMB Authenticated Read Response message may include the requested data comprising the block count number of bytes beginning at the logical address specified in the RPMB Read Request Message from a corresponding one of the RPMB regions 334A-D.

In some embodiments, a MAC is generated two times with the same set of inputs, including a RPMB authentication key, an address, a nonce, a block count, and a write counter of the RPMB Read Request Message. First, the memory controller of the host device calculates a first MAC while formatting RPMB request packet and inserts the MAC in the read request message. Second, the memory controller or cryptography engine or other component of the memory system 330 determines a second MAC based on the same values when the read request is received. The authentication key used by the memory controller of the host device may be stored on the host device and retrieved for computing the first MAC. The authentication key used by the memory system 330 may be stored in the memory system 330 and retrieved for computing the second MAC.

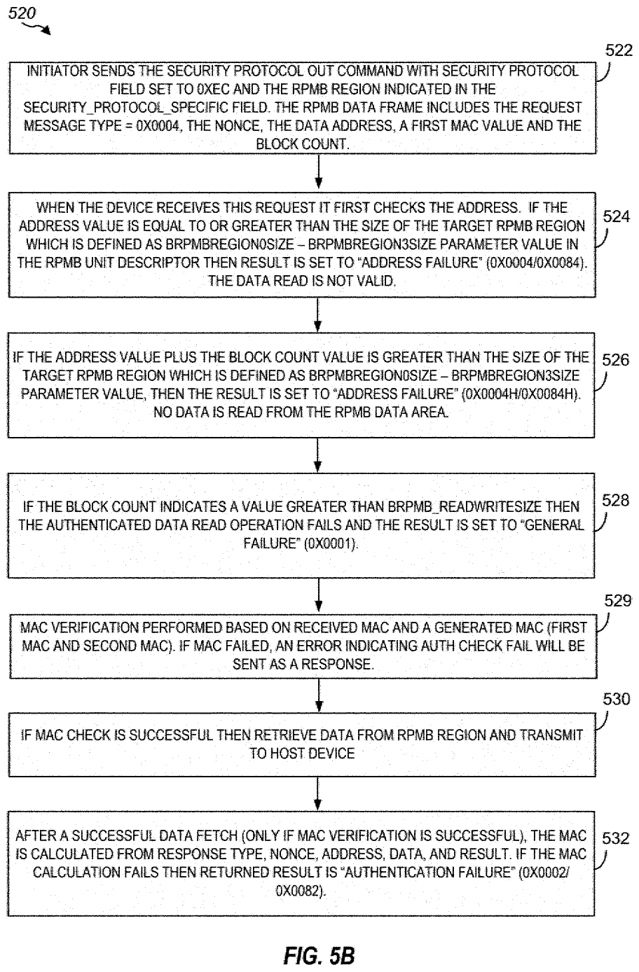

A method of performing the operation of FIG. 4 by the memory system 330 is shown in the flow chart of FIG. 5A. FIG. 5A is a flow chart illustrating an authenticated read request according to one or more aspects of the disclosure. The method may be performed by an apparatus, such as that of FIG. 3, having a memory controller that is coupled to a memory module through a first channel and to a host device through a first interface. The memory controller may be configured to access data stored in the memory module through the first channel and configured to communicate with the host device over the first interface.

The method 500 may include, at block 502, receiving a read request for requested data stored in a replay protected memory block (RPMB) portion of the memory module. The read request may include first information corresponding to the RPMB portion located at a specified address of the read request. The first information used to authenticate the read request may alternatively or additionally include any information included in the read request or response, such as requested data, a nonce value, a write counter value, an address value, a block count value, or a request message type of the read request.

Authentication may be performed by comparing two values, the first value computed from first information in the read request and a first authentication key in the host device and the second value computed from the first information in the read request and second information (e.g., a second authentication key) stored in the memory system. At block 506, the method 500 may include determining a second value based on second information stored in the memory module and the first information.

At block 508, the method 500 may include determining whether the read request is valid based on comparing the first value with the second value. In some embodiments, whether the read request is valid may also be determined by checking whether the read request is to a valid memory region. For example, the determination may include determining whether an address and a block count of the first information corresponding to the RPMB portion in the read request corresponds to a valid region for the RPMB portion, wherein determining whether the read request is valid is based on determining the address and the block count corresponds to a valid region of the memory module for the RPMB portion.

At block 510, the method 500 may include transmitting the requested data to the host device through the first interface based on the determining whether the read request is valid. If the read request is not valid based on either the MAC comparison or the address and block count then the memory system may transmit an authentication failure response to the host device based on the determining whether the read request is valid. The secure data in the RPMB regions requested by the read request may not be transmitted to the host device until after determining whether the read request is valid. Performing the MAC check and, optionally, other verifications, may prevent unauthorized access to the secure data in the RPMB regions. This method of authenticating access in the memory system is more secure than releasing the requested data to the host device and allowing the host device to control access to the requested data.

One specific embodiment for authenticating an authenticated read request in a Universal Flash Storage (UFS) system is shown in FIG. 5B. FIG. 5B is a flow chart illustrating an authenticated read request according to one or more aspects of the disclosure. A method 520 includes, at block 522, an initiator sending the security protocol out command with security protocol field set to 0xEC and the RPMB region indicated in the security_protocol_specific field. The RPMB data frame includes the request message type 0x0004, the nonce, the data address, a MAC value, and a write counter value, and the block count.

At block 524, the method 520 may include, when the device receives this request, first checking the address. If the address value is equal to or greater than the size of the target RPMB region, which is defined as brpmbregion0size−brpmbregion3size parameter value in the RPMB unit descriptor, then the result is set to “address failure” (0x0004/0x0084). The data read is not valid.

At block 526, the method 520 may include, if the address value plus the block count value is greater than the size of the target RPMB region which is defined as brpmbregion0size−brpmbregion3size parameter value, then the result is set to “address failure” (0x0004 h/0x0084h), and no data is read from the RPMB data area.

At block 528, the method 520 may include, if the block count indicates a value greater than brpmb_readwritesize then the authenticated data read operation fails and the result is set to “general failure” (e.g., 0x0001).

At block 530, the method 520 may include performing a MAC check on memory device based on a MAC calculated from response type, nonce, address, data, and result. The MAC check compares the MAC calculated by the memory system with a MAC included in the RPMB Read Request Message. If the MAC check results in a failure, the operation returns “authentication failure” (0x0002/0x0082) and does not provide the requested data.

At block 532, the method 520 may include, if the MAC check is successful then retrieving data from the RPMB region and transmitting the requested data to the host device. For example, after a successful data fetch (only if MAC verification is successful), the mac is calculated from response type, nonce, address, data, and result. If the MAC calculation fails then the returned result is “authentication failure” (0x0002/0x0082).

FIGS. 4, 5A, and 5B describe methods and operations for a memory device to authenticate a read request transmitted to the memory system from a host device. The memory system is configured to perform the methods and operations as described herein. The host device may be configured similarly to the memory controller of the memory system to facilitate maintaining the security of the data in the RPMB portion of the memory module by submitting read requests as described herein and processing response messages as described herein.

Operations of method 500 or 520 may be performed by a UE, a BS, or other devices, such as a UE described with reference to FIG. 6. For example, example operations (also referred to as “blocks”) of method 500 or 520 may enable UE 115 to support greater user data confidentiality. FIG. 6 is a block diagram illustrating details of an example wireless communication system according to one or more aspects. The wireless communication system may include wireless network 600. Wireless network 600 may, for example, include a 5G wireless network. As appreciated by those skilled in the art, components appearing in FIG. 6 are likely to have related counterparts in other network arrangements including, for example, cellular-style network arrangements and non-cellular-style-network arrangements (e.g., device to device or peer to peer or ad hoc network arrangements, etc.).

Wireless network 600 illustrated in FIG. 6 includes a number of base stations 605 and other network entities. A base station may be a station that communicates with the UEs and may also be referred to as an evolved node B (eNB), a next generation eNB (gNB), an access point, and the like. Each base station 605 may provide communication coverage for a particular geographic area. In 3GPP, the term “cell” may refer to this particular geographic coverage area of a base station or a base station subsystem serving the coverage area, depending on the context in which the term is used. In implementations of wireless network 600 herein, base stations 605 may be associated with a same operator or different operators (e.g., wireless network 600 may include a plurality of operator wireless networks). Additionally, in implementations of wireless network 600 herein, base station 605 may provide wireless communications using one or more of the same frequencies (e.g., one or more frequency bands in licensed spectrum, unlicensed spectrum, or a combination thereof) as a neighboring cell. In some examples, an individual base station 605 or UE 615 may be operated by more than one network operating entity. In some other examples, each base station 605 and UE 615 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 6, base stations 605d and 605e are regular macro base stations, while base stations 605a-605c are macro base stations enabled with one of 3 dimension (3D), full dimension (FD), or massive MIMO. Base stations 605a-605c take advantage of their higher dimension MIMO capabilities to exploit 3D beamforming in both elevation and azimuth beamforming to increase coverage and capacity. Base station 605f is a small cell base station which may be a home node or portable access point. A base station may support one or multiple (e.g., two, three, four, and the like) cells.

Wireless network 600 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 615 are dispersed throughout the wireless network 600, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Within the present document, a “mobile” apparatus or UE need not necessarily have a capability to move, and may be stationary. Some non-limiting examples of a mobile apparatus, such as may include implementations of one or more of UEs 615, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA).

A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC).

In another aspect, a UE may be a device that does not include a UICC. In some aspects, UEs that do not include UICCs may also be referred to as IoE devices. UEs 615a-615d of the implementation illustrated in FIG. A are examples of mobile smart phone-type devices accessing wireless network 600. A UE may also be a machine specifically configured for connected communication, including machine type communication (MTC), enhanced MTC (eMTC), narrowband IoT (NB-IoT) and the like. UEs 615e-615k illustrated in FIG. 6 are examples of various machines configured for communication that access wireless network 600.

A mobile apparatus, such as UEs 615, may be able to communicate with any type of the base stations, whether macro base stations, pico base stations, femto base stations, relays, and the like. In FIG. A, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 600 may occur using wired or wireless communication links.

In operation at wireless network 600, base stations 605a-605c serve UEs 615a and 615b using 3D beamforming and coordinated spatial techniques, such as coordinated multipoint (CoMP) or multi-connectivity. Macro base station 605d performs backhaul communications with base stations 605a-605c, as well as small cell, base station 605f. Macro base station 605d also transmits multicast services which are subscribed to and received by UEs 615c and 615d. Such multicast services may include mobile television or stream video, or may include other services for providing community information, such as weather emergencies or alerts, such as Amber alerts or gray alerts.

Wireless network 600 of implementations supports mission critical communications with ultra-reliable and redundant links for mission critical devices, such UE 615e, which is a flying vehicle. Redundant communication links with UE 615e include from macro base stations 605d and 605e, as well as small cell base station 605f. Other machine type devices, such as UE 615f (thermometer), UE 615g (smart meter), and UE 615h (wearable device) may communicate through wireless network 600 either directly with base stations, such as small cell base station 605f, and macro base station 605e, or in multi-hop configurations by communicating with another user device which relays its information to the network, such as UE 615f communicating temperature measurement information to the smart meter, UE 615g, which is then reported to the network through small cell base station 605f. Wireless network 600 may also provide additional network efficiency through dynamic, low-latency TDD communications or low-latency FDD communications, such as in a vehicle-to-vehicle (V2V) mesh network between UEs 615i-615k communicating with macro base station 605e.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANs.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In one or more aspects, techniques for supporting data storage and/or data transmission, may include additional aspects, such as any single aspect or any combination of aspects described below or in connection with one or more other processes or devices described elsewhere herein. In a first aspect, an electronic device, such as a UE, may be an apparatus as a host device that includes a memory controller configured to couple to an interface to a memory system, in which the memory system may be integrated with the host device or externally coupled to the host device. The memory system may include a memory controller coupled to a memory module through a first channel and configured to access data stored in the memory module through the first channel and coupled to a host device through a first interface and configured to communicate with the host device over the first interface. The operations may be executed as part of an initialization operation, a read operation or a write operation.

In a first aspect, the memory controller of the memory system may be configured to perform operations including receiving a read request for requested data stored in a replay protected memory block (RPMB) portion of the memory module, wherein the read request comprises first information corresponding to the RPMB portion and a first message authentication code (MAC) determined by the host device based on at least a portion of the first information; determining a second message authentication code (MAC) based on second information stored in the memory module and the first information; determining whether the read request is valid based on comparing the first MAC with the second MAC; and transmitting the requested data to the host device through the first interface based on the determining whether the read request is valid.

In a second aspect, in combination with the first aspect, wherein the first information comprises an address, a nonce, a block count, and a write counter.

In a third aspect, in combination with one or more of the first aspect or the second aspect, wherein the first MAC is based on a first authentication key stored on the host device, and wherein determining the second MAC is based on second information comprising a second authentication key stored by the memory controller.

In a fourth aspect, in combination with one or more of the first aspect through the third aspect, wherein the first information comprises at least one of an address, a nonce, a block count, and a write counter.

In a fifth aspect, in combination with one or more of the first aspect through the fourth aspect, the operations further include determining whether an address and a block count of the first information corresponding to the RPMB portion in the read request corresponds to a valid region for the RPMB portion, wherein determining whether the read request is valid is based on determining the address and the block count corresponds to a valid region of the memory module for the RPMB portion.

In a sixth aspect, in combination with one or more of the first aspect through the fifth aspect, the operations further include transmitting an authentication failure response to the host device based on the determining whether the read request is valid.

In a seventh aspect, in combination with one or more of the first aspect through the sixth aspect, the operations further include not transmitting the requested data to the host device until after determining whether the read request is valid.

In an eighth aspect, in combination with one or more of the first aspect through the seventh aspect, wherein the requested data comprises at least one of a user identifier, a password, a digital rights management (DRM) key, a secure file system key, or a rollback version of a computer program product.

In a ninth aspect, in combination with one or more of the first aspect through the eighth aspect, a method includes wherein the memory system comprises a universal flash storage (UFS) device.

In a tenth aspect, in combination with one or more of the first aspect through the ninth aspect, the method includes wherein determining the second message authentication code comprises determining a HMAC SHA-256 value based on a first address, a nonce, a block count, and a write counter in the first information and based on an authentication key stored by the memory controller.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 4, 5A, or 5B may be combined with one or more blocks (or operations) described with reference to another of the figures. For example, one or more blocks (or operations) of FIG. 1 may be combined with one or more blocks (or operations) of FIG. 3. As another example, one or more blocks associated with FIG. 1 may be combined with one or more blocks (or operations) associated with FIG. 4, 5A, or 5B. Additionally, or alternatively, one or more operations described above with reference to FIGS. 1-2 may be combined with one or more operations described with reference to FIGS. 4-5.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus, comprising:
a memory controller:
coupled to a memory module through a first channel and configured to access data stored in the memory module through the first channel; and
coupled to a host device through a first interface and configured to communicate with the host device over the first interface,
the memory controller configured to perform operations comprising:
receiving a read request for requested data stored in a replay protected memory block (RPMB) portion of the memory module, wherein the read request comprises first information corresponding to the RPMB portion and a first message authentication code (MAC) determined by the host device based on at least a portion of the first information;
determining a second message authentication code (MAC) based on second information stored in the memory module and the first information;
determining whether the read request is valid based on comparing the first MAC with the second MAC; and
transmitting the requested data to the host device through the first interface based on the determining whether the read request is valid.

2. The apparatus of claim 1, wherein the first information comprises an address, a nonce, a block count, and a write counter.

3. The apparatus of claim 2, wherein the first MAC is based on a first authentication key stored on the host device, and wherein determining the second MAC is based on second information comprising a second authentication key stored by the memory controller.

4. The apparatus of claim 1, wherein the first information comprises at least one of an address, a nonce, a block count, and a write counter.

5. The apparatus of claim 1, wherein the memory controller is further configured to perform operations comprising:
determining whether an address and a block count of the first information corresponding to the RPMB portion in the read request corresponds to a valid region for the RPMB portion,
wherein determining whether the read request is valid is based on determining the address and the block count corresponds to a valid region of the memory module for the RPMB portion.

6. The apparatus of claim 1, wherein the memory controller is further configured to perform operations comprising: transmitting an authentication failure response to the host device based on the determining whether the read request is valid.

7. The apparatus of claim 1, wherein the memory controller is further configured to perform operations comprising: not transmitting the requested data to the host device until after determining whether the read request is valid.

8. The apparatus of claim 1, wherein the requested data comprises at least one of a user identifier, a password, a digital rights management (DRM) key, a file system key, or a rollback version of a computer program product.

9. (canceled)

10. The apparatus of claim 1, wherein determining the second message authentication code comprises determining a HMAC SHA-256 value based on a first address, a nonce, a block count, and a write counter in the first information and based on an authentication key stored by the memory controller.

11. A method, comprising:
receiving, by a memory controller of a memory system, a read request for requested data stored in a replay protected memory block (RPMB) portion of a memory module in the memory system through a first interface coupling the memory system with a host device, wherein the read request comprises first information corresponding to the RPMB portion and a first message authentication code (MAC) determined by the host device based on at least a portion of the first information;
determining, by the memory controller, a second message authentication code (MAC) based on second information stored in the memory system and the first information;
determining, by the memory controller, whether the read request is valid by comparing the first MAC with the second MAC; and
transmitting, by the memory controller, the requested data to through the first interface when the read request is determined valid.

12. The method of claim 11, wherein the first information comprises an address, a nonce, a block count, and a write counter.

13. The method of claim 12, wherein the first MAC is based on a first authentication key stored on the host device, and wherein determining the second MAC is based on second information comprising a second authentication key stored by the memory controller.

14. The method of claim 11, wherein the first MAC is based on a first authentication key stored on the host device, and wherein determining the second MAC is based on second information comprising a second authentication key stored by the memory controller.

15. The method of claim 11, further comprising:
determining whether an address and a block count of the first information corresponding to the RPMB portion in the read request corresponds to a valid region for the RPMB portion,
wherein transmitting the requested data is performed based on determining the address and the block count corresponds to a valid region for the RPMB portion.

16. The method of claim 11, further comprising: transmitting an authentication failure response to the host device based on the determining whether the read request is valid.

17. The method of claim 11, further comprising: not transmitting the requested data until after determining whether the read request is valid.

18. The method of claim 11, wherein the requested data comprises at least one of a user identifier, a password, a digital rights management (DRM) key, a file system key, or a rollback version of a computer program product.

19-20. (canceled)

21. An apparatus, comprising:
a memory controller of a host device configured to couple the host device to a memory system through a first interface, the memory controller configured to perform operations including:
transmitting a read request for requested data stored in a replay protected memory block (RPMB) portion of the memory system, the read request comprising a first message authentication code (MAC) based on first information corresponding to the RPMB portion, the first information comprising at least an address, a nonce, a block count, and a write counter; and
receiving a read response from the memory system, wherein the read response is based on the memory system determining whether the read request is valid based on comparing the first message authentication code (MAC) and a second message authentication code (MAC) determined by the memory system.

22. The apparatus of claim 21, wherein receiving the read response from the memory system comprises:
receiving an authentication failure response from the host device based on the determining whether the read request is valid determining the read request is invalid; and
receiving the requested data from the host device based on the determining whether the read request is valid determining the read request is valid, wherein the requested data is not transmitted until after determining the read request is valid.

23. The apparatus of claim 21, wherein the requested data comprises at least one of a user identifier, a password, a digital rights management (DRM) key, a file system key, or a rollback version of a computer program product.

24-30. (canceled)
